(19) United States
(12) Patent Application Publication
(10) Pub. No.: US 2025/0076526 A1
(43) Pub. Date: Mar. 6, 2025

(54) SYSTEM AND METHOD FOR SELECTING A SITE FOR A NUCLEAR REACTOR

(71) Applicant: KING FAHD UNIVERSITY OF PETROLEUM AND MINERALS, Dhahran (SA)

(72) Inventors: Naveed IQBAL, Dhahran (SA); Afaque SHAMS, Dhahran (SA); Khaled AL-ATHEL, Dhahran (SA); Ali AL-SHAIKHI, Dhahran (SA)

(73) Assignee: KING FAHD UNIVERSITY OF PETROLEUM AND MINERALS, Dhahran (SA)

(21) Appl. No.: 18/459,655

(22) Filed: Sep. 1, 2023

(51) Int. Cl. G01V 1/00; G01V 1/18; G01V 1/30

(52) U.S. Cl. CPC G01V 1/003; G01V 1/181; G01V 1/307; G01V 2210/1425; G06F 17/142

(57) ABSTRACT

A method for determining a safe distance between a seismic source and an installation location of a nuclear reactor is disclosed. The method includes obtaining seismic data from a seismic sensor network located proximate the seismic source. The seismic sensor network includes a plurality of geophones each having seismic data receiver and configured to record seismic signals received from a geological formation under the installation location of the nuclear reactor. The plurality of geophones is communicatively coupled with a seismic data processor. The method includes processing seismic data with the seismic data processor to obtain an instantaneous frequency component from each of the geophones, comparing each of the instantaneous frequency components with a fundamental horizontal frequency of a substructure of nuclear reactor to determine a matching instantaneous frequency component, and determining safe distance between seismic source and installation location of the nuclear reactor based on matching instantaneous frequency component.

### BACKGROUND

### Technical Field

The present disclosure is directed to a system and a method for selecting a site for a nuclear reactor. In particular, the present disclosure is related to a system and a method for determining a safe distance between a seismic source and an installation location of a nuclear reactor.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Seismic exploration is the process of using seismic energy to explore beneath the Earth's surface for economic mineral, oil, or gas resources, as well as for archaeological, engineering, and scientific research. Seismic acquisition requires using a seismic source at specified locations for a seismic survey. The energy that travels within the subsurface, as seismic waves generated by the source, gets recorded at specified locations on the surface by receivers (for example, geophones). Known seismic source frequencies range from 12 to 60 Hz.

Below, various exemplary conventional references are listed that discuss seismic exploration. Electric Power Research Institute (EPRI) described a list of sequential processes for site selection for a nuclear reactor (See: EPRI, “Siting guide: Site selection and evaluation criteria for an early site permit application,” tech. rep., 1006878, pp 229, Palo Alto, CA, 2002, incorporated herein by reference in its entirety). The EPRI's sequential processes are also summarized and recommended by the International Atomic Energy Agency (IAEA) as a general process to select the site for a nuclear reactor (See: IAEA, “Managing siting activities for nuclear power plants,” tech. rep., no. NG-T-3.7, Vienna, Austria, 2012, incorporated herein by reference in its entirety). However, none of the prior art references discuss the impact of seismically induced signals on core damage frequency as part of the probabilistic risk assessment (PRA).

Furthermore, continuous data from a single seismo-acoustic station about 50 meters distant from a nuclear research reactor was visualized and analyzed (See: Chai et al., “Monitoring operational states of a nuclear reactor using seismoacoustic signatures and machine learning,” Seismological Society of America, vol. 93, no. 3, pp. 1660-1672, 2022., incorporated herein by reference in its entirety). The reference demonstrates a distinct link between seismo-acoustic features and primary operational modes of the nuclear research reactor. Additionally, a preliminary review was conducted for the earlier investigations of seismic analysis (See: Khericha et al., “Seismically induced accident sequence analysis of the advanced test reactor,” tech. rep., 1991, incorporated herein by reference in its entirety). As described in the reference, the fundamental horizontal frequencies of the substructure are in the range of 10-20 Hz which overlaps with the seismic frequency range. Each of the aforementioned references suffers from one or more drawbacks hindering their adoption.

Accordingly, there is a need for systems and methods that facilitate the selection of a site for a nuclear reactor.

### SUMMARY

In an exemplary embodiment, a method for determining a safe distance between a seismic source and an installation location of a nuclear reactor is disclosed. The method includes obtaining seismic data from a seismic sensor network located proximate a seismic source. The seismic sensor network includes a plurality of geophones each having a seismic data receiver and configured to record a plurality of seismic signals received from a geological formation under the installation location of the nuclear reactor. The plurality of geophones is communicatively coupled with a seismic data processor. The method further includes processing the seismic data with the seismic data processor to obtain an instantaneous frequency component from each of the geophones, and comparing each of the instantaneous frequency components with a fundamental horizontal frequency of a substructure of the nuclear reactor to determine a matching instantaneous frequency component. The method includes determining the safe distance between the seismic source and the installation location of the nuclear reactor based on the matching instantaneous frequency component. The method also includes determining the matching instantaneous frequency component includes identifying the instantaneous frequency component that is in a frequency range of the fundamental horizontal frequency.

In some embodiments, the fundamental horizontal frequency is in a frequency range of 10-20 Hz.

In some embodiments, determining the matching instantaneous frequency component further includes identifying a first geophone of the seismic sensor network associated with the matching instantaneous frequency component.

In some embodiments, determining the safe distance between the seismic source and the installation location of the nuclear reactor includes determining a distance between a location of the first geophone and the seismic source as the safe distance between the seismic source and the installation location of the nuclear reactor.

In some embodiments, the seismic data includes time series data.

In some embodiments, processing the seismic data includes applying Short-Time Fourier Transform on the seismic data to obtain the instantaneous frequency component.

In some embodiments, the instantaneous frequency component is a center frequency of a frequency band associated with the seismic data of each geophone.

In another exemplary embodiment, an article of manufacture is disclosed. The article of manufacture includes a computer-readable storage medium storing computer-readable instructions for determining a safe distance between a seismic source and an installation location of a nuclear reactor. The instructions include instructions for obtaining seismic data from a geophone network located proximate a seismic source. The geophone network has a plurality of geophones each having a seismic data receiver and configured to record a plurality of seismic signals received from a geological formation under the installation location of the nuclear reactor. The instructions further include instructions for processing the seismic data to obtain an instantaneous frequency component from each of the geophones and instructions for comparing each of the instantaneous frequency components with a fundamental horizontal frequency of a substructure of the nuclear reactor to determine a matching instantaneous frequency component. The instructions further include instructions for determining the safe distance between the seismic source and the installation location of the nuclear reactor based on the matching instantaneous frequency component.

In some embodiments, the instructions for determining the safe distance between the seismic source and the installation location of the nuclear reactor include instructions for identifying a first geophone of the geophone network associated with the matching instantaneous frequency component, and instructions for determining a distance between a location of the first geophone and the seismic source as the safe distance between the seismic source and the installation location of the nuclear reactor.

In some embodiments, the instructions for determining the matching instantaneous frequency component include instructions for identifying the instantaneous frequency component that is in a frequency range of the fundamental horizontal frequency.

In some embodiments, the instantaneous frequency component is a center frequency of a frequency band associated with the seismic data of each geophone.

In another exemplary embodiment, a system is disclosed. The system includes a memory storing set of instructions and a processor configured to execute the set of instructions to cause the system to perform a method of obtaining seismic data from a seismic sensor network located proximate a seismic source. The seismic sensor network includes a plurality of geophones each having a seismic data receiver and configured to record a plurality of seismic signals received from a geological formation under an installation location of the nuclear reactor. The plurality of geophones is communicatively coupled with a seismic data processor. The processor is configured to process the seismic data with the seismic data processor to obtain instantaneous frequency component from each of the geophones, compare each of the instantaneous frequency components with a fundamental horizontal frequency of a substructure of the nuclear reactor to determine a matching instantaneous frequency component, and determine a safe distance between the seismic source and the installation location of the nuclear reactor based on the matching instantaneous frequency component.

In some embodiments, processing the seismic data obtain the instantaneous frequency component includes applying Short-Time Fourier Transform on the seismic data to obtain a center frequency of a frequency band associated with seismic data of each geophone.

In some embodiments, determining the matching instantaneous frequency component includes identifying the center frequency that is in a frequency range of the fundamental horizontal frequency.

In some embodiments, the fundamental horizontal frequency is in a frequency range of 10-20 Hz.

In some embodiments, determining the safe distance between the seismic source and the installation location of the nuclear reactor includes identifying a first geophone of the seismic sensor network associated with the matching instantaneous frequency component, and determining a distance between a location of the first geophone and the seismic source as the safe distance between the seismic source and the installation location of the nuclear reactor.

In some embodiments, the seismic sensor network is installed at a first distance from the seismic source and the geophones are installed at a specified distance from each other.

In some embodiments, the specified distance is 5 meters.

In some embodiments, the geophones are installed in a straight line.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows a block diagram of a system for determining a safe distance between a seismic source and an installation location of a nuclear reactor, according to certain embodiments.

FIG. 2 depicts a plot of acquired seismic data, according to certain embodiments.

FIG. 3 depicts a plot illustrating short-time Fourier transform (STFT) applied to a first geophone that is near to seismic source, according to certain embodiments.

FIG. 4 depicts a plot illustrating STFT applied to a second geophone that is 80 meters away from the seismic source, according to certain embodiments.

FIG. 5 depicts a method for determining a safe distance between the seismic source and an installation location of nuclear reactor, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to systems and methods for determining a safe distance between a seismic source and an installation location of a nuclear reactor. In particular, aspects of the present disclosure are directed to systems and methods for selecting a site for a nuclear reactor near the oil and gas exploration region. The site selection for a nuclear reactor is a crucial safety and security activity with escalating demands.

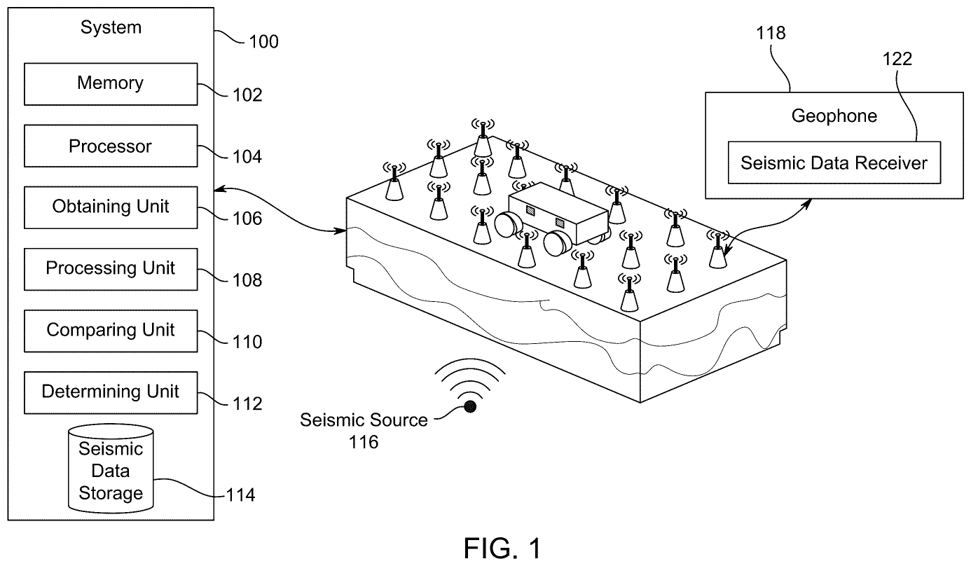

FIG. 1 shows a block diagram of a system 100 for determining a safe distance between a seismic source and an installation location of a nuclear reactor, according to certain embodiments.

The system 100 includes a memory 102 for storing program instructions and at least one processor 104 (interchangeably referred to as seismic data processor 104) configured to execute program instructions. The processor 104 may be any logic circuitry that responds to and processes instructions fetched from the memory 102. In many embodiments, the processor 104 may be provided by a microprocessor unit, e.g., those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The processor 104 may utilize instruction-level parallelism, thread-level parallelism, different levels of cache, and multi-core processors. A multi-core processor may include two or more processing units on a single computing component. Examples of multi-core processors include the AMD PHENOM IIX2, INTER CORE i5, and INTEL CORE i7.

The memory 102 may include one or more memory chips capable of storing data and allowing any storage location to be directly accessed by the processor 104. The memory 102 may be Dynamic Random-Access Memory (DRAM) or any variants, including static Random-Access Memory (SRAM), Burst SRAM (BSRAM), Fast Page Mode DRAM (FPM DRAM), Enhanced DRAM (EDRAM), Double Data Rate SDRAM (DDR SDRAM), Direct Rambus DRAM (DRDRAM), or Extreme Data Rate DRAM (XDR DRAM). In some embodiments, the memory 102 may be non-volatile; e.g., non-volatile read access memory (NVRAM), flash memory non-volatile static RAM (nvSRAM), Ferroelectric RAM (FeRAM), Magnetoresistive RAM (MRAM), Resistive RAM (RRAM), Racetrack, Nano-RAM (NRAM), or Millipede memory. The memory 102 may be based on any of the above-described memory chips, or any other available memory chips capable of operating as described herein.

The system 100 also includes an obtaining unit 106, a processing unit 108, a comparing unit 110, and a determining unit 112. In an implementation, the obtaining unit 106, the processing unit 108, the comparing unit 110, and the determining unit 112 may be coupled to the processor 104 and the memory 102. In some embodiments, the obtaining unit 106, the processing unit 108, the comparing unit 110, and the determining unit 112, amongst other units, may include routines, programs, objects, components, data structures, etc., which may perform particular tasks or implement particular abstract data types. The obtaining unit 106, the processing unit 108, the comparing unit 110, and the determining unit 112 may also be implemented as, signal processor(s), state machine(s), logic circuitries, and/or any other device or component that manipulates signals based on operational instructions.

In some embodiments, the obtaining unit 106, the processing unit 108, the comparing unit 110, and the determining unit 112 may be implemented in hardware, instructions executed by a processing module, or by a combination thereof. The processing module may comprise a computer, a processor, a state machine, a logic array or any other suitable devices capable of processing instructions. The processing module may be a general-purpose processor that executes instructions to cause the general-purpose processor to perform the required tasks or the processing module may be dedicated to performing the required functions. In some embodiments, the obtaining unit 106, the processing unit 108, the comparing unit 110, and the determining unit 112 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in the memory 102. Although, the processor 104 and the processing unit 108 are shown as separate components, in an implementation, the processor 104 and the processing unit 108 may be configured to function as a single unit. The system 100 also includes a seismic data storage 114. The seismic data storage 114 may store seismic data. In examples, the seismic data includes time series data. The seismic data exhibits an apparent relationship between seismic features and primary operational frequency of the nuclear reactor.

The system 100 is communicatively coupled to a seismic source 116 and a plurality of geophones 118-(1-N) ((all geophones 118-(1-N) are subsequently referred to as geophone 118-1 however, the description may be generalized to any of geophones 118-(1-N)) via a seismic sensor network 120 (also referred to as geophone network 120). Each of the plurality of geophones 118-(1-N) includes a seismic data receiver 122-(1-N). The plurality of geophones 118-(1-N) is communicatively coupled with the processor 104. In an implementation, each of the plurality of geophones 118-(1-N) is configured to record a plurality of seismic signals received from the geological formation under the installation location of the nuclear reactor. In some implementations, the seismic sensor network 120 may include the plurality of geophones 118-(1-N).

According to an embodiment, the seismic sensor network 120 may be connected via wired and/or wireless links. Wired links may include coaxial cable lines, or optical fiber lines. Wireless links may include Bluetooth®, Wi-Fi®, Worldwide Interoperability for Microwave Access (WiMAX®), an infrared channel or a satellite band. The wireless links may also include any cellular network standards to communicate among mobile devices. The network standards may qualify as one or more generations of mobile telecommunication standards by fulfilling a specification or standards such as the specifications maintained by the International Telecommunication Union. Examples of cellular network standards include Advanced Mobile Phone System (AMPS), Global System for Mobile (GSM), General Packet Radio Services (GPRS), Universal Mobile Telecommunications Service (UMTS), and Code-Division Miltiple Access (CDMA). In some embodiments, different types of data may be transmitted via different links and standards. In other embodiments, the same types of data may be transmitted via different links and standards.

In operation, the obtaining unit 106 may be configured to obtain (or acquire) seismic data from the seismic sensor network 120 located proximate to the seismic source 116. The geophones 118-(1-N) are configured to sense the seismic signals (e.g., generated by the seismic source 116) and record the sensed seismic signals. Each of the geophones 118-(1-N) may include a seismic data receiver 122-(1-N). The seismic data receivers 122-(1-N) are configured to record the seismic signals. The seismic signals may be generated naturally in geological formations of Earth or generated using seismic generators, such as the seismic source 116. The seismic data receivers 122-(1-N) are configured to capture direct, reflected and/or refracted seismic signals and process the recorded seismic signals to generate seismic data. In examples, the seismic data may include time series data. The obtaining unit 106 may store the obtained seismic data in seismic data storage 114. As described earlier, the seismic sensor network 120 includes the plurality of geophones 118-(1-N), each having a seismic data receiver 122-(1-N). Each of the seismic data receivers 122-(1-N) are configured to record a plurality of seismic signals received from the geological formation under the installation location of the nuclear reactor.

In an implementation, the processing unit 108 may be configured to process the seismic data to obtain instantaneous frequency component from each of the geophones 118-(1-N). In examples, the processing unit 108 may process the seismic data by applying Short-Time Fourier Transform (STFT) on the seismic data to obtain the instantaneous frequency component in the time-frequency plan. The instantaneous frequency component is a center frequency of a frequency band associated with the seismic data of each geophone 118-(1-N). The instantaneous frequency component helps to identify the impact of seismic signatures on the nuclear reactor. In examples, the frequency content at various geophones 118-(1-N) may differ as a result of the waves being reflected, refracted, and/or diffracted depending on the structure of the Earth's layers at the locations of the corresponding geophones. As a result, analyzing the frequency content enables the identification of geophones 118-(1-N) with frequency components similar to the fundamental frequency range of a substructure of the nuclear reactor. In some embodiments, installing a nuclear reactor at location where the frequency component matches with the fundamental frequency range of the substructure of the nuclear reactor, or matches with the resonant frequency of the nuclear reactor, is safer than installing the nuclear reactor at other locations.

According to an implementation, the comparing unit 110 may be configured to compare each of the instantaneous frequency components with a fundamental horizontal frequency of a substructure of the nuclear reactor to determine a matching instantaneous frequency component. In examples, to determine the matching instantaneous frequency component, the comparing unit 110 may be configured to identify the center frequency that is in a frequency range of the fundamental horizontal frequency. In examples, the fundamental horizontal frequency is in a frequency range of 10-20 Hz.

The determining unit 112 may be configured to determine a safe distance between the seismic source 116 and the installation location of the nuclear reactor based on the matching instantaneous frequency component. To determine the safe distance between the seismic source 116 and the installation location of the nuclear reactor, the determining unit 112 may identify a first geophone (for example, geophone 118-1) of the seismic sensor network 120 associated with the matching instantaneous frequency component. Further, the determining unit 112 may determine a distance between a location of the first geophone and the seismic source 116 as the safe distance between the seismic source 116 and the installation location of the nuclear reactor. That is, the location of a geophone whose instantaneous frequency component matches or is within the range of a fundamental horizontal frequency of a nuclear substructure (e.g., 10-20 Hz) may be identified as the installation location of the nuclear reactor. Accordingly, the acquired seismic data may be used to identify the geophone that picked up the signal at a frequency that corresponds to the fundamental horizontal frequencies of the substructure of the nuclear reactor. Based on the analysis, a potential site for the nuclear reactor may be selected, for example, in an oil and gas-rich region.

In an implementation, the seismic sensor network 120 is installed at a first distance from the seismic source 116, and the geophones 118-(1-N) are installed at a specified distance from each other. In an example, the specified distance is 5-10 meters. Further, the geophones 118-(1-N) may be installed in a straight line (i.e., horizontally) with similar spacing.

### EXAMPLES

The following examples describe and demonstrate exemplary embodiments as described herein. The examples are provided solely for the purpose of illustration and are not to be construed as limitations of the present disclosure, as many variations thereof are possible without departing from the spirit and scope of the present disclosure.

### Examples and Experiments

### Experimental Data and Analysis

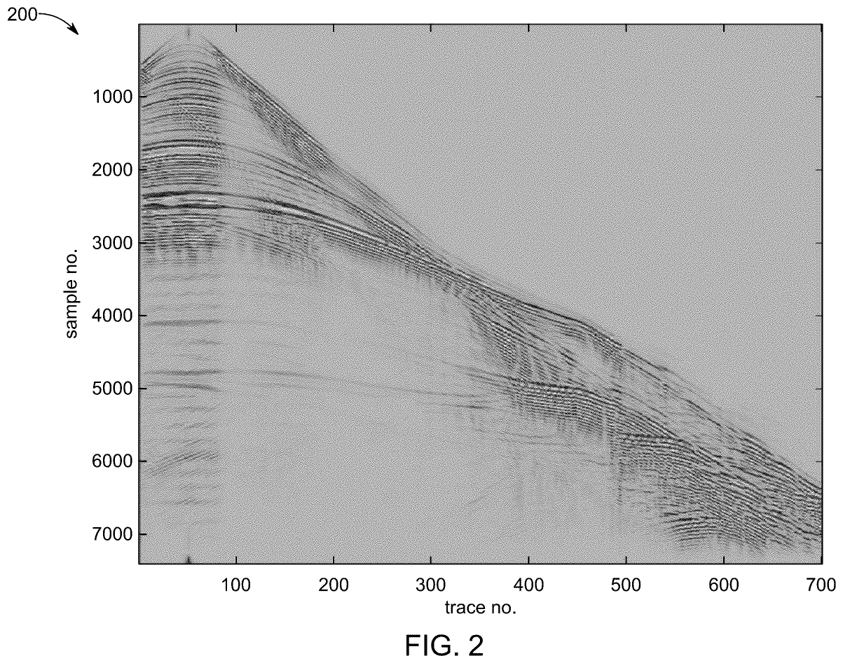

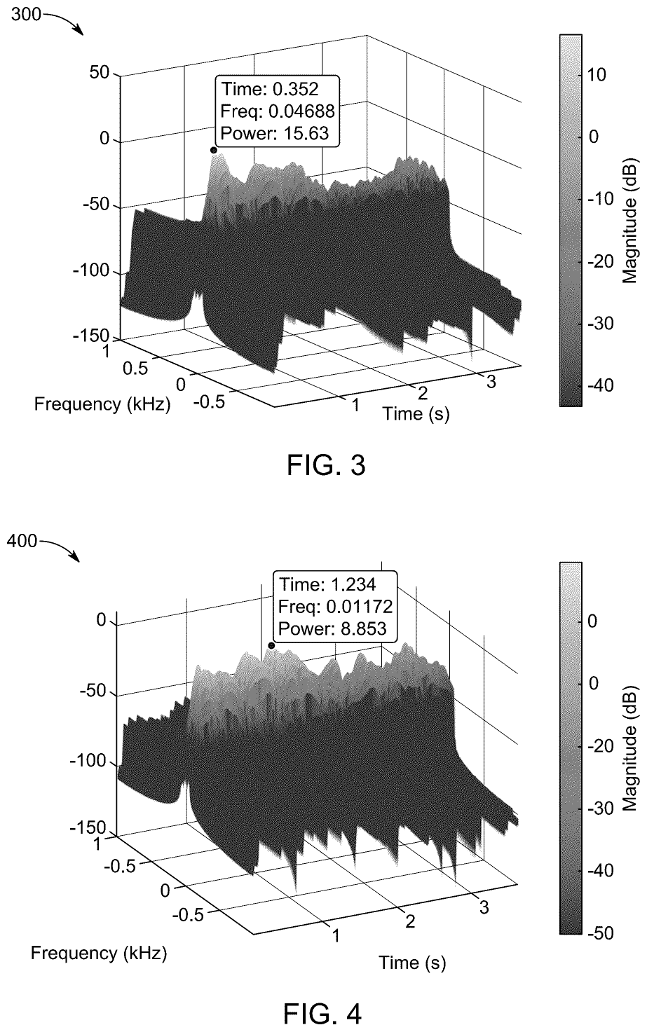

In the experiment, seismic data was acquired from 700 geophones spaced 5 meters apart horizontally. FIG. 2 depicts a plot 200 of acquired seismic data, according to certain embodiments. Short-time Fourier transform (STFT) was utilized to analyze the seismic data acquired from the geophones. FIG. 3 depicts a plot 300 illustrating STFT applied to a first geophone that is near to the seismic source (for example, the seismic source 116), according to certain embodiments. In an example, the first geophone may be geophone 118-1. FIG. 4 depicts a plot 400 illustrating STFT applied to a second geophone that is 80 meters away from the seismic source, according to certain embodiments. In an example, the second geophone may be any geophone from amongst the geophones 118-(2-N). For example, the second geophone may be geophone 118-16. In particular, FIG. 3 and FIG. 4 depict the frequencies present in the time-series data for the first geophone and the second geophone, respectively. The first geophone is closer to the seismic source 116 than the second geophone and includes a center frequency of 46 Hz, whereas the second geophone has frequency contents around 11 Hz which is in the range of the nuclear reactor's resonance frequency (e.g., 10-20Hz). Accordingly, in this scenario, the nuclear reactor is safe if structured at a distance of 80 meters from the seismic source. This analysis can be further extended to noisy seismic signals.

The present disclosure also describes an article of manufacture. Examples of the article of manufacture include, but are not limited to, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

In an aspect, the article of manufacture includes a computer-readable storage medium storing computer-readable instructions for determining a safe distance between the seismic source 116 and an installation location of a nuclear reactor. The instructions include instructions for obtaining seismic data from the geophone network 120 located proximate the seismic source 120. The geophone network 120 includes a plurality of geophones 118-(1-N), each having a seismic data receiver 122-(1-N) and configured to record a plurality of seismic signals received from a geological formation under the installation location of the nuclear reactor. The instructions further include instructions for processing the seismic data to obtain an instantaneous frequency component from each of the geophones 118-(1-N), instructions for comparing each of the instantaneous frequency components with a fundamental horizontal frequency of a substructure of the nuclear reactor to determine a matching instantaneous frequency component, and instructions for determining the safe distance between the seismic source 116 and the installation location of the nuclear reactor based on the matching instantaneous frequency component.

In examples, the instructions for determining the safe distance between the seismic source 116 and the installation location of the nuclear reactor include instructions for identifying a first geophone (for example, the geophone 118-1) of the geophone network 120 associated with the matching instantaneous frequency component, and instructions for determining a distance between a location of the first geophone and the seismic source 116 as the safe distance between the seismic source 116 and the installation location of the nuclear reactor. Further, the instructions for determining the matching instantaneous frequency component include instructions for identifying the instantaneous frequency component that is in a frequency range of the fundamental horizontal frequency. In examples, the instantaneous frequency component is a center frequency of a frequency band associated with the seismic data of each geophone 118-(1-N).

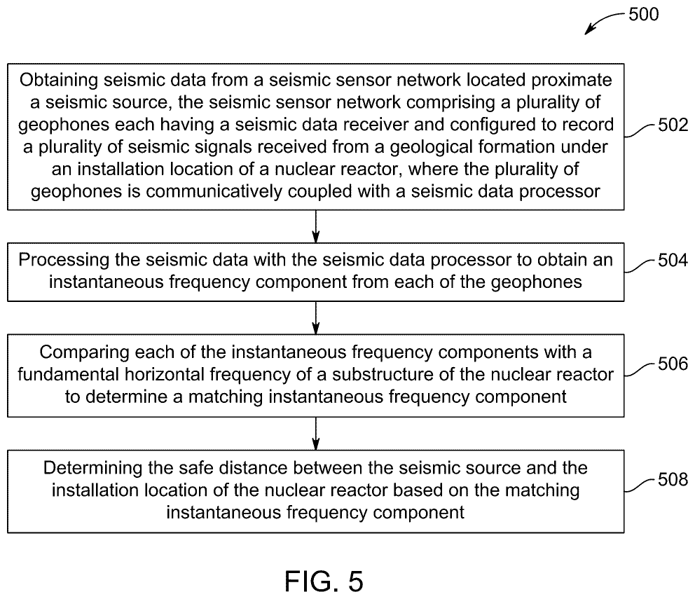

Referring to FIG. 5, a method 500 for determining a safe distance between the seismic source 116 and an installation location of a nuclear reactor is described. The order in which the method 500 is described is not intended to be construed as a limitation, and any number of the described method steps can be combined in any order to implement the method 500. Additionally, individual steps may be removed or skipped from the method 500 without departing from the spirit and scope of the present disclosure.

At step 502, the method 500 includes obtaining seismic data from the seismic sensor network 120 located proximate the seismic source 116. The seismic sensor network 120 includes the plurality of geophones 118-(1-N), each having the seismic data receiver 122-(1-N) and configured to record a plurality of seismic signals received from a geological formation under the installation location of the nuclear reactor. The plurality of geophones 118-(1-N) is communicatively coupled with the seismic data processor 104. According to an implementation, the obtaining unit 106 may be configured to obtain the seismic data from the seismic sensor network 120 located proximate the seismic source 116.

At step 504, the method 500 includes processing the seismic data with the seismic data processor 104 to obtain an instantaneous frequency component from each of the geophones 118-(1-N). According to an implementation, the processing unit 108 may be configured to process the seismic data with the seismic data processor 104 to obtain an instantaneous frequency component from each of the geophones 118-(1-N).

At step 506, the method 500 includes comparing each of the instantaneous frequency components with a fundamental horizontal frequency of a substructure of the nuclear reactor to determine a matching instantaneous frequency component. According to an implementation, the comparing unit 110 may be configured to compare each of the instantaneous frequency components with the fundamental horizontal frequency of the substructure of the nuclear reactor to determine the matching instantaneous frequency component. In an implementation, to determine the matching instantaneous frequency component, the comparing unit 110 may be configured to identify the instantaneous frequency component that is in a frequency range of the fundamental horizontal frequency. In examples, the fundamental horizontal frequency is in a frequency range of 10-20 Hz. In some implementations, to determine the matching instantaneous frequency component, the comparing unit 110 may be configured to identify a first geophone of the seismic sensor network 120 associated with the matching instantaneous frequency component. In an example, the first geophone may be any one of the geophones 118-(1-N).

At step 508, the method 500 includes determining the safe distance between the seismic source 116 and the installation location of the nuclear reactor based on the matching instantaneous frequency component. According to an implementation, the determining unit 112 may be configured to determine the safe distance between the seismic source 116 and the installation location of the nuclear reactor based on the matching instantaneous frequency component.

The above description can demonstrate a distinct link between seismic properties and the operation of the nuclear reactor. In some embodiments, deep learning methods (e.g., artificial intelligence such as machine learning (ML)) may be used to determine operational modes or power level of a nuclear reactor. For example, a first ML model may be trained to determine an operational mode (e.g., “On” state (full power operation), “Off” state (end-of-cycle outage) or “Transition” state (intermediate stage when the nuclear reactor switches from Off to On)) of the nuclear reactor based on seismic data. Continuing with the example, a second ML model may be trained to determine the power level of the nuclear reactor (e.g., “10%,” “30%,” “50%,” “75%,” “90%” of the total power) based on seismic data. In some embodiments, the ML models may be supervised ML models that categorizes the input seismic data into one of the above categories of operation modes or power levels. For example, the first ML model may determine the operational mode of the nuclear reactor as one of the “On,” “Off,” or “Transition” states for a given seismic data input. Similarly, the second ML model may determine the power level of the nuclear reactor as one of the “10%,” “30%,” “50%,” “75%,” “90%” power levels for a given seismic data input. The seismic data may be obtained from seismic sensors, such as geophones, located near the nuclear reactor. In some embodiments, the second ML model may be used to determine the power level when the first ML model determines the operational mode as “Transition” as the power level in the other two operational modes are known.

The ground truth data for training the ML models may be derived using data obtained from monitoring systems of the nuclear reactor. For example, for different power levels measured by the monitoring systems of the nuclear reactor corresponding seismic data may be obtained from the geophones and labelled with the respective power level. Similarly, the operational modes are obtained from the monitoring systems of the nuclear reactor and the corresponding seismic data obtained from the geophones is labelled with the respective operational modes. In some embodiments, the two ML models may be trained independently. In some embodiments, the ML models may be pre-trained ML models that are trained with the ground truth data associated with a number of nuclear reactors, different types of nuclear reactors, nuclear reactors located in different geographies, etc. The pre-trained ML models may be further fine-tuned for a particular nuclear reactor (e.g., trained with the ground truth of the given nuclear reactor) to provide the predictions for the given nuclear reactor.

Numerous modifications and variations of the present disclosure are possible in light of the above teachings. It is therefore to be understood that within the scope of the appended claims, the invention may be practiced otherwise than as specifically described herein.

1. A method for determining a safe distance between a seismic source and an installation location of a nuclear reactor, the method comprising:
obtaining seismic data from a seismic sensor network located proximate a seismic source, the seismic sensor network comprising a plurality of geophones each having a seismic data receiver and configured to record a plurality of seismic signals received from a geological formation under the installation location of the nuclear reactor, wherein the plurality of geophones is communicatively coupled with a seismic data processor;
processing the seismic data with the seismic data processor to obtain an instantaneous frequency component from each of the geophones;
comparing each of the instantaneous frequency components with a fundamental horizontal frequency of a substructure of the nuclear reactor to determine a matching instantaneous frequency component; and
determining the safe distance between the seismic source and the installation location of the nuclear reactor based on the matching instantaneous frequency component.

2. The method of claim 1, wherein determining the matching instantaneous frequency component includes identifying the instantaneous frequency component that is in a frequency range of the fundamental horizontal frequency.

3. The method of claim 1, wherein the fundamental horizontal frequency is in a frequency range of 10-20 Hz.

4. The method of claim 1, wherein determining the matching instantaneous frequency component further includes:
identifying a first geophone of the seismic sensor network associated with the matching instantaneous frequency component.

5. The method of claim 4, wherein determining the safe distance between the seismic source and the installation location of the nuclear reactor includes:
determining a distance between a location of the first geophone and the seismic source as the safe distance between the seismic source and the installation location of the nuclear reactor.

6. The method of claim 1, wherein the seismic data includes time series data.

7. The method of claim 1, wherein processing the seismic data includes:
applying Short-Time Fourier Transform on the seismic data to obtain the instantaneous frequency component.

8. The method of claim 7, wherein the instantaneous frequency component is a center frequency of a frequency band associated with the seismic data of each geophone.

9. An article of manufacture comprising:
a computer-readable storage medium storing computer-readable instructions for determining a safe distance between a seismic source and an installation location of a nuclear reactor, the instructions comprising:
instructions for obtaining seismic data from a geophone network located proximate a seismic source, the geophone network having a plurality of geophones each having a seismic data receiver and configured to record a plurality of seismic signals received from a geological formation under the installation location of the nuclear reactor;
instructions for processing the seismic data to obtain an instantaneous frequency component from each of the geophones;
instructions for comparing each of the instantaneous frequency components with a fundamental horizontal frequency of a substructure of the nuclear reactor to determine a matching instantaneous frequency component; and
instructions for determining the safe distance between the seismic source and the installation location of the nuclear reactor based on the matching instantaneous frequency component.

10. The article of manufacture of claim 9, wherein the instructions for determining the safe distance between the seismic source and the installation location of the nuclear reactor include:
instructions for identifying a first geophone of the geophone network associated with the matching instantaneous frequency component; and
instructions for determining a distance between a location of the first geophone and the seismic source as the safe distance between the seismic source and the installation location of the nuclear reactor.

11. The article of manufacture of claim 9, wherein the instructions for determining the matching instantaneous frequency component include:
instructions for identifying the instantaneous frequency component that is in a frequency range of the fundamental horizontal frequency.

12. The article of manufacture of claim 9, wherein the instantaneous frequency component is a center frequency of a frequency band associated with the seismic data of each geophone.

13. A system comprising:
a memory storing set of instructions; and
a processor configured to execute the set of instructions to cause the system to perform a method of:
obtaining seismic data from a seismic sensor network located proximate a seismic source, the seismic sensor network comprising a plurality of geophones each having a seismic data receiver and configured to record a plurality of seismic signals received from a geological formation under an installation location of the nuclear reactor, wherein the plurality of geophones is communicatively coupled with a seismic data processor;
processing the seismic data with the processor to obtain instantaneous frequency component from each of the geophones;
comparing each of the instantaneous frequency components with a fundamental horizontal frequency of a substructure of the nuclear reactor to determine a matching instantaneous frequency component; and
determining a safe distance between the seismic source and the installation location of the nuclear reactor based on the matching instantaneous frequency component.

14. The system of claim 13, wherein processing the seismic data obtain the instantaneous frequency component includes:
applying Short-Time Fourier Transform on the seismic data to obtain a center frequency of a frequency band associated with seismic data of each geophone.

15. The system of claim 14, wherein determining the matching instantaneous frequency component includes identifying the center frequency that is in a frequency range of the fundamental horizontal frequency.

16. The system of claim 13, wherein the fundamental horizontal frequency is in a frequency range of 10-20 Hz.

17. The system of claim 13, wherein determining the safe distance between the seismic source and the installation location of the nuclear reactor includes:
identifying a first geophone of the seismic sensor network associated with the matching instantaneous frequency component; and
determining a distance between a location of the first geophone and the seismic source as the safe distance between the seismic source and the installation location of the nuclear reactor.

18. The system of claim 13, wherein the seismic sensor network is installed at a first distance from the seismic source and the geophones are installed at a specified distance from each other.

19. The system of claim 18, wherein the specified distance is 5 meters.

20. The system of claim 13, wherein the geophones are installed in a straight line.
